(19) United States
(12) Patent Application Publication
(10) Pub. No.: US 2024/0419162 A1
(43) Pub. Date: Dec. 19, 2024

(54) ADAPTIVE ONLINE CONDITION MONITORING

(71) Applicant: University of Kentucky Research Foundation, Lexington, KY (US)

(72) Inventors: Peng Wang, Lexington, KY (US); Matthew Russell, Nicholasville, KY (US)

(21) Appl. No.: 18/748,909

(22) Filed: Jun. 20, 2024

Related U.S. Application Data
(60) Provisional application No. 63/521,858, filed on Jun. 19, 2023.

(51) Int. Cl. G05B 23/02

(52) U.S. Cl. CPC G05B 23/024; G05B 23/0254

(57) ABSTRACT

The present disclosure describes methods for machine condition monitoring from unlabeled sensing data. The methods include providing a plurality of sensors including at least one acceleration sensor. The plurality of sensors are adapted for obtaining a plurality of high-frequency time series inputs from an operating rotating machine or machine component. The plurality of high-frequency time series inputs received from the plurality of sensors are subjected to one or more augmentation transformations that diversify the plurality of high-frequency time series inputs without impacting condition information. This provides a plurality of augmented inputs which, by the one or more augmentation transformations, are selected to randomize input amplitude and phase.

### RELATED APPLICATIONS

This application claims priority to U.S. provisional patent application Ser. No. 63/521,858 filed on Jun. 19, 2023, the entirety of the disclosure of which is incorporated herein by reference.

### GOVERNMENT INTEREST

This invention was made with partial government support under grant number CMMI-2015889 awarded by the National Science Foundation. The government has certain rights in the invention.

### TECHNICAL FIELD

The presently-disclosed subject matter generally relates to data-driven maintenance. In particular, certain embodiments of the presently-disclosed subject matter relate to a novel method for predicting a maintenance requirement or optimal interval for machinery such as rotating machinery.

### BACKGROUND

Data-driven models show promise for assessing machine health in real-time and enabling cost-saving Predictive Maintenance. Advances in Deep Learning (DL) can automatically extract valuable features from Condition Monitoring (CM) data when complex process-observation relationships are not well understood. However, significant roadblocks hinder practical deployments since these models assume that test-time conditions match training conditions. Training data largely comes from normal conditions, so deployed models often encounter unknown faults without ground truth labels. Considering these constraints, practical predictive models for CM must satisfy certain requirements: R1) learn from unlabeled sensing observations, R2) learn novel conditions not represented in the initial training data, also referred to as Continual Learning (CL) and R3) adapt to these unpredictable shifts in data on the fly.

Machine data is often unlabeled and from very few health conditions (e.g., only normal operating data). Furthermore, models often encounter shifts in domain as process parameters change and new categories of faults emerge. Traditional supervised learning may struggle to learn compact, discriminative representations that generalize to these unseen target domains since it depends on having plentiful classes to partition the feature space with decision boundaries. Transfer Learning (TL) with domain adaptation attempts to adapt these models to unlabeled target domains but assumes similar underlying structure that may not be present if new faults emerge. This disclosure focuses on maximizing the feature generality on the source domain and applying TL via weight transfer to copy the model to the target domain. Specifically, Self-Supervised Learning (SSL) with Barlow Twins may produce more discriminative features for monitoring health condition than supervised learning by focusing on semantic properties of the data. Furthermore, Federated Learning (FL) for distributed training may also improve generalization by efficiently expanding the effective size and diversity of training data by sharing information across multiple client machines. Results show that Barlow Twins outperforms supervised learning in an unlabeled target domain with emerging motor faults when the source training data contains very few distinct categories. Incorporating FL may also provide a slight advantage by diffusing knowledge of health conditions between machines.

Building on advancements in SSL and CL, the present disclosure presents methods for adaptive online CM that apply Barlow Twins to 1D time series data from rotating machinery and further provides a novel Mixed-Up Experience Replay (MixER) analysis that extends Lifelong Unsupervised Mixup (LUMP) analyses, improving on the state-of-the-art unsupervised CL from computer vision. The described methods advantageously include: 1) the novel application of Barlow Twins SSL to CM data with specifically selected time series augmentations for unlabeled 1D signals to achieve R1, 2) a novel adaptive online CM architecture and pipeline that proposes Mixed-Up Experience Replay (MixER) for CL to achieve R2 and R3, and 3) experiments validating MixER by comparing clustering performance of state-of-the-art unsupervised CL approaches on unlabeled data from successive observed motor health conditions.

### SUMMARY

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

In one aspect, the present disclosure is directed to a computer-implemented method for machine condition monitoring from unlabeled sensing data. The method includes a step of providing a plurality of sensors comprising at least one acceleration sensor, the plurality of sensors being adapted for obtaining a plurality of high-frequency time series inputs from an operating rotating machine or rotating machine component. A computing device or system comprising memory, storage, and one or more processors is configured to receive the plurality of high-frequency time series inputs from the plurality of sensors. The one or more processors include computer-readable instructions for applying one or more augmentation transformations to the plurality of high-frequency time series inputs. The one or more augmentation transformations diversify the plurality of high-frequency time series inputs without impacting condition information to provide a plurality of augmented inputs, the one or more augmentation transformations being selected to randomize input amplitude and phase.

In embodiments, the one or more processors fuse the plurality of high-frequency time series inputs into a multi-channel input prior to the step of applying the one or more augmentation transformations. In embodiments, the one or more processors further include computer-readable instructions for selecting the one or more augmentation transformations from the group consisting of: random flipping, scaling, jitter, masking a random data portion of a high-frequency time series input of the plurality of high-frequency time series inputs, and combinations thereof. In an embodiment, the scaling is applied with a factor of at least 0.1.

In embodiments, the one or more processors further include computer-readable instructions for analyzing the augmented inputs according to a Barlow Twins Self-Supervised Learning (SSL) model utilizing a stack-up of one-dimensional convolutional neural network (CNN) residual blocks to provide a restoration loss value, a distillation loss value, and a task loss value. The one or more processors further include computer-readable instructions for applying a Mixed-up Experience Replay (MixER) model which uses the restoration loss value, the distillation loss value, and the task loss value to update the Barlow Twins SSL model according to previously observed rotating machine conditions.

The one or more processors then classify a current rotating machine condition according the updated features to predict a required rotating machine maintenance operation or an optimal rotating machine maintenance interval.

It will be understood that various details of the presently disclosed subject matter can be changed without departing from the scope of the subject matter disclosed herein. Furthermore, the foregoing description is for the purpose of illustration only, and not for the purpose of limitation.

### BRIEF DESCRIPTION OF THE DRAWINGS

The presently-disclosed subject matter will be better understood, and features, aspects and advantages other than those set forth above will become apparent when consideration is given to the following detailed description thereof. Such detailed description makes reference to the following drawings, wherein:

FIG. 1 illustrates SSL encouragement of compactness and separation of pseudoclasses while supervised representations are dependent on decision boundaries.

FIG. 2 schematically illustrates a method for comparing discriminability of emerging faults when transferring weights from a supervised or self-supervised 1D CNN feature extraction backbone, followed by efficient information sharing among multiple client machines by Federated Learning.

FIG. 3 illustrates the architectures for the 1D CNN backbone feature extractor, supervised K-class classifier, and Barlow Twins projection head.

FIG. 4 shows a Fed Avg FL algorithm.

FIG. 5 illustrates how each client experiences different conditions, and that averaging model weights diffuses this knowledge to other clients thus maximizing the diversity of the data set and improving performance on emerging faults.

FIG. 6 schematically illustrates a system architecture for CL to monitor machine health, with dashed lines between models indicating shared weights.

FIG. 7 shows value ranges for hyperparameter searches.

FIG. 8 illustrates in flowchart form a data processing pipeline for adaptive online CM according to the present disclosure.

FIG. 9A shows Transfer Learning health condition sets.

FIG. 9B shows Federated Learning health condition sets.

FIG. 10A shows Transfer Learning evaluation accuracy results (%).

FIG. 10B shows Federated Learning accuracy results (%).

FIG. 11 graphically illustrates a target domain accuracy of the weight transfer methods on motor (8) condition versus number of faults in the training domain.

FIG. 12 shows representative confusion matrices showing advantages of using Barlow Twins over supervised learning when transferring models to new process parameters (3L→2H) with six emerging conditions.

FIG. 13 shows an algorithm for random augmentations for Barlow Twins in PyTorch style.

FIG. 14 graphically illustrates client evaluation accuracies on all health conditions.

FIG. 15 shows representative confusion matrices showing the benefits of including FL for Barlow Twins Client 1.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

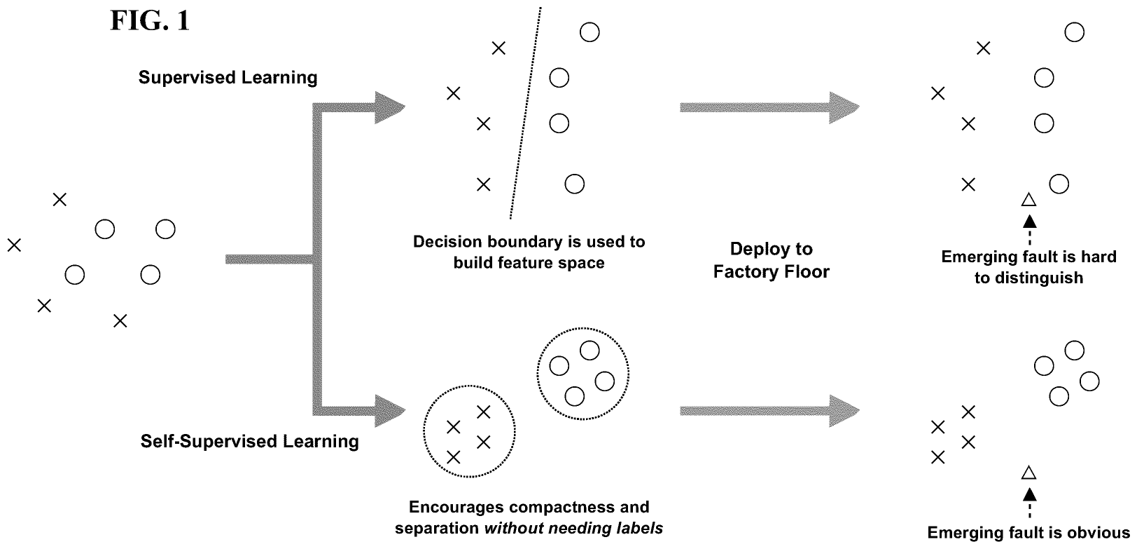

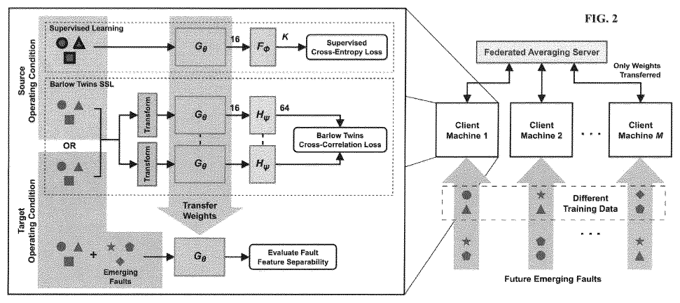

Although supervised learning on massively diverse data sets may produce generalizable features, it may struggle when class (i.e., fault/condition) diversity is limited in two ways by (1) producing less compact clusters, and (2) allowing noise or systematic biases to dom-inant feature extraction. A simple classification objective constructs the feature space and decision boundaries without explicitly encouraging compact clusters (see FIG. 1). With limited training classes, the model has few decision boundaries with which to partition the feature space. This could produce loosely structured features, increasing the likelihood that features from future emerging faults will overlap those from previous health conditions. While adding compactness objectives may help, fewer classes also means the model has fewer observations from varied environmental conditions and process parameters. Since DL implementations are free to learn features themselves, a supervised model could resort to systematic biases to separate data rather than the more complex underlying fault signals as intended. Combining data from distributed machines could mitigate these issues by increasing class diversity, but aggregating high-velocity sensing streams could be difficult given bandwidth constraints. Furthermore, most raw data will be unlabeled regardless, making large-scale supervised learning impossible. The proposed method instead adopts SSL to support unlabeled data and improve the feature space structure and FL to expand the effective data set size without inundating communication networks or introducing privacy concerns (see FIG. 2). Together, these techniques learn a more discriminative feature space that generalizes to new operating conditions and emerging faults.

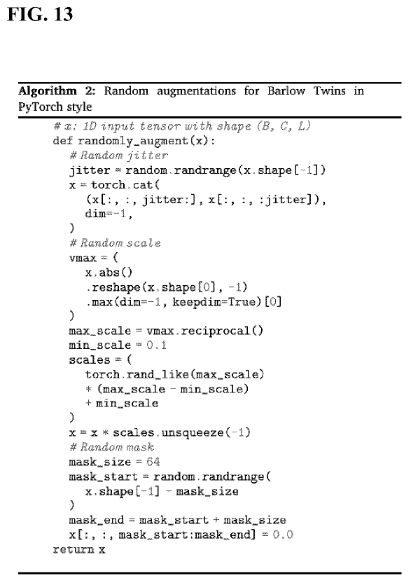

Replacing supervised learning with SSL introduces the knowledge-informed assumption that although emerging faults or new operating conditions have not been observed, this time series data from the target domain will have similar building blocks and salient characteristics—e.g., frequency content—that discriminates them. To extract these salient indicators instead of unwanted biases, SSL relies on expert-designed random data augmentations that indicate the expected variation with the signals. Barlow Twins SSL seeks to tightly cluster feature projections from different augmentations of the same observation by maximizing the cross-correlation between projections. This ensures that examples falling within the expected signal variation are grouped closely together. The augmentations themselves should be informed by knowledge of condition monitoring signals to randomize unimportant signal attributes while preserving the semantic class. Extending the proposed augmentations, Algorithm 2 (see FIG. 13) outlines the random transformations used with Barlow Twins in the proposed methods for condition monitoring. The examples are randomly shifted (jittered) in time, scaled, and masked. Given input batch X of n examples, feature extraction backbone G [symbol] , projector H, Barlow Twins first computes the projections of two augmented versions X′ and X″ of the input batch (according to Algorithm 2) and their corresponding projections Z′=H (G [symbol] (X′)) and Z″=H (G [symbol] (X″)). Then both sets of projections are normalized across the batch:

$$\begin{matrix}{μ}_{i} = \frac{1}{n} {\sum }_{k = 1}^{n} {Z}_{ik} \\ {σ}_{i}^{2} = \frac{1}{n} {\sum }_{k = 1}^{n} {( {Z}_{ik} - {μ}_{i} )}^{2} \\ {\hat{Z}}_{ij} = ( {Z}_{ij} - {μ}_{i} ) / {σ}_{i}\end{matrix} \qquad ( 5 )$$

Next, the cross-correlation matrix R is computed and normalized by the batch size:

$$R = {\hat{Z}}^{′} {\hat{Z}}^{″ T} / n \qquad ( 6 )$$

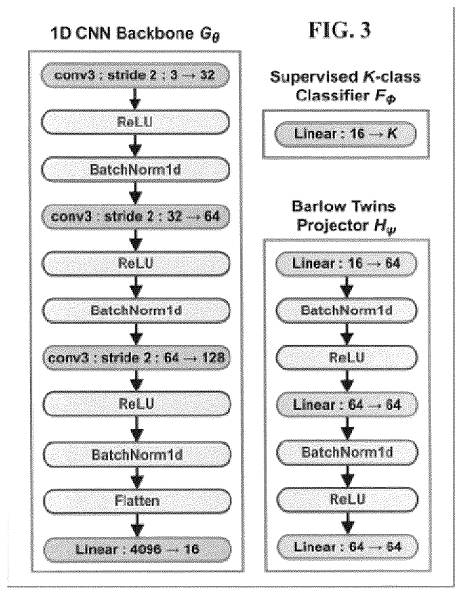

Finally, the loss function can be calculated using R:

$${ℒ}_{BT} ( R ) = tr ( {( R - I )}^{2} ) + λ {\sum }_{j} {\sum }_{j \neq i} {R}_{ji} \qquad ( 7 )$$

where λ controls the strength of the independence constraint. The first term encourages the diagonal elements to be one, meaning that individual features are highly correlated (aligned) across the batch, meaning that instances within the expected variation—as defined by the applied random augmentations—will map to similar feature projections (i.e., cluster together). The second term drives off-diagonal elements to zero so each feature is independent from the rest. This improves the representational capacity by ensuring multiple features do not encode the same information. With this loss function, the Barlow Twins feature extractor and projection head can be trained with standard stochastic gradient descent and backpropagation methods. FIG. 3 shows the architecture of the 1D CNN backbone for extracting features from condition monitoring data and the Barlow Twins projection head.

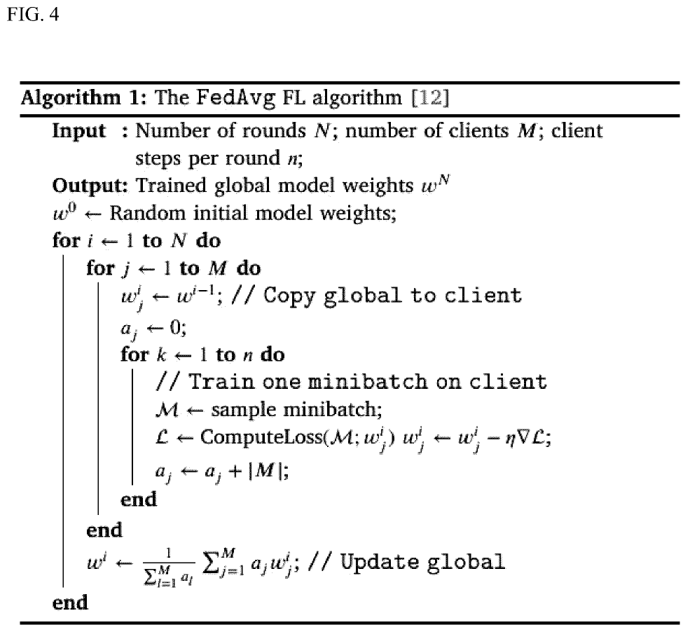

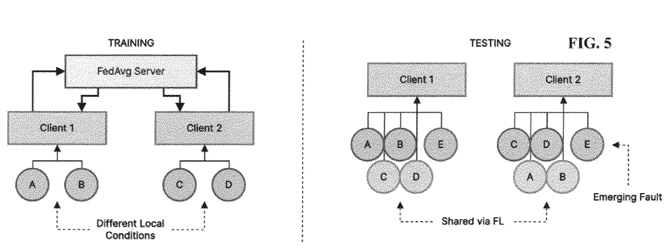

Most factory floors will have multiple similar machines that will each experience different health conditions throughout operation. Data from a single machine may contain very few distinct conditions, but network constraints may prevent each machine from streaming all its sensing data to the cloud to construct a unified data set. The machines themselves may not be geographically colocated or may belong to separate manufacturers without data-sharing agreements. To circumvent these hindrances, the model can be trained with FedAvg (see Algorithm 1, FIG. 4). Each client machine retains complete ownership of its data while indirectly gaining knowledge about new health conditions through model averaging on the FL server. This indirect information sharing between clients via the global model can be viewed as a form of TL. When each client receives an updated global model, they benefit from the observations and knowledge of the other clients. Thus, even if a client lacks training experience with a given health condition, if another client has trained with that condition, the FL algorithm will diffuse this experience back to the uninformed client (see FIG. 5). Thus, FL may offer TL advantages among the clients, improving the generalization of each one to future fault conditions. Moreover, The client machines only send updated models to the FL server once per round, significantly reducing the volume and velocity of data trans-mitted to the cloud. By combining FL with SSL, DL can operate in realistic condition monitoring scenarios with unlabeled, distributed training data while reducing network communication and maintaining manufacturer privacy.

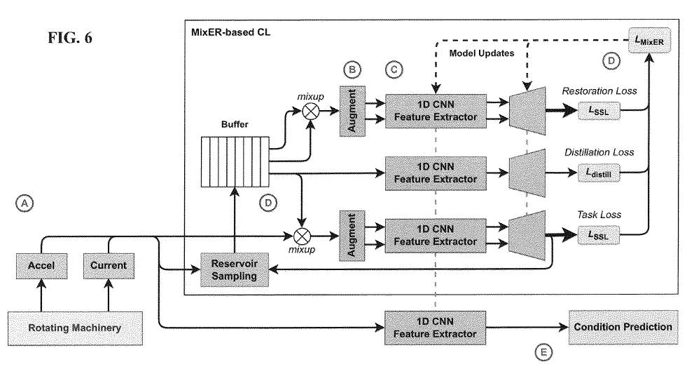

FIG. 6 shows a framework for adaptive online CM using Mixed-Up Experience Replay (MixER) with Barlow Twins SSL for CL on unsupervised time series signals. Acceleration and current sensors collect high-frequency time series signals from rotating machinery for the predictive model (A in FIG. 6).

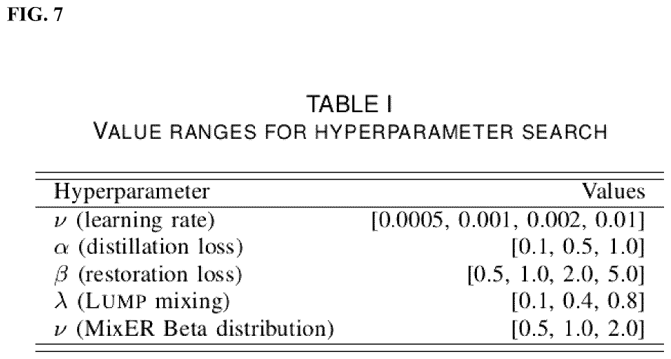

The framework applies simple transformations (B in FIG. 6) to diversify the signals without destroying important semantic (i.e., condition) information. The augmentations consist of random flipping, scaling with a factor from 0.1 to 1.0, jitter up to the length of the window, and masking (zeroing) a random 64-point section of the signal (see FIG. 7). From a physical standpoint, these transformations randomize amplitude and phase to obscure time series artifacts while preserving frequency content important for rotating machinery signals. Augmented examples are passed to Barlow Twins SSL (C in FIG. 6) with three 1D CNN feature extractor blocks (see FIG. 6) that extract features while improving backward gradient flow versus regular CNN layers. A projector embeds the features into a metric space where cross-correlation loss is applied. Representing the CNN encoder as f_{θ} with parameters θ and projection head g_{ϕ} with parameters ϕ, the projections from batch x of N examples are h=g_{ϕ}(f_{θ}(x)). The normalized values are ĥ=(h−h̅)/σₕ where h̅ and σₕ are the mean and standard deviation of each feature across the batch. Cross-correlation between ĥₐ and ĥ_{b} from two different augmentations of the same seed example is:

$$R = {\hat{h}}_{a}^{T} {\hat{h}}_{b} / N$$

The Barlow Twins loss function is

$${ℒ}_{B T} = {\sum }_{i} {( 1 - {R}_{ii} )}^{2} + γ {\sum }_{i} {\sum }_{j \neq i} {R}_{ij}^{2}$$

where the first term is an “invariance term” that encourages similar features from the same seed example, and the second term is a “redundancy reduction term” (with scaling factor γ) that encourages independence among features.

To adapt the representation to emerging faults (novel conditions), the disclosed method includes a novel MixER algorithm (D in FIG. 6). MixER combines LUMP with DER++, training the Barlow Twins model on mixed-up examples of both emerging faults and past experience. Mixing up past experience improves data diversity to prevent overfitting. The machine condition can then be classified for predictive maintenance (E in FIG. 6).

While LUMP successfully combined SSL with DER, it left out the restoration loss term from DER++ that applied task loss (e.g. Barlow Twins loss) to examples from the replay buffer. The described Mixed-Up Experience Replay (MixER) demonstrates adds this restoration term on unlabeled experience in the unsupervised setting, alongside the task and distillation loss with linear mixup (see Exhibit A for variable definitions):

$${ℒ}_{MixER} = {\underbrace{{ℒ}_{SSL} ( {x}^{′} )}}_{task loss} + {\underbrace{α {‖ {g}_{ϕ} ( {f}_{θ} ( \tilde{x} ) ) - \tilde{h} ‖}_{2}^{2}}}_{distillation loss} + {\underbrace{{βℒ}_{SSL} ( {\tilde{x}}^{′} )}}_{restoration loss}$$

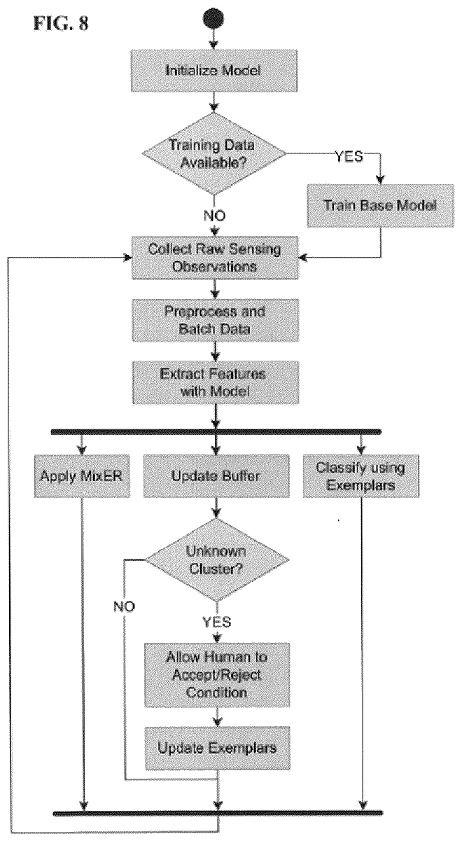

FIG. 8 surveys a data processing pipeline for adaptive online CM using the proposed framework. While the model could be pretrained offline, it can also be deployed without prior training. Once features are extracted, MixER loss provides the gradients to refine the representation via Barlow Twins on unlabeled data (R1) without forgetting previous conditions (R2). Reservoir sampling curates the experience replay buffer of 100 256-point windows without needing condition change points (R3). The system flags new feature clusters that could indicate emerging faults and enables experts to decide if they are a fault or a benign change in process parameters. Within this framework, this study seeks to validate MixER-based CL.

### Experiments

Since MixER depends on Barlow Twins, experiments are designed to verify Barlow Twins can learn from unlabeled time series data containing all eight operating conditions. Subsequently, CL experiments with emerging faults compare the feature representations produced by DER, DER++, LUMP, and MixER from unlabeled data. Two case studies are presented. The first compares the generalizability of representations after pretraining with supervised learning or SSL on varying numbers of distinct classes. The second examines the impact of distributed training with FL on model performance under emerging faults.

### Motor Condition Data Set

Both case studies use a motor fault condition data set collected from the SpectraQuest Machinery Fault Simulator (MFS; SpectraQuest, Inc., Richmond VA). With a 12 kHz sampling rate, two accelerometers mounted orthogonally capture vibration data, and a current clamp measures electrical current signals. Sixty seconds of steady-state data is gathered for eight motor health conditions: normal (N), faulted bearings (FB), bowed rotor (BoR), broken rotor (BrR), misaligned rotor (MR), unbalanced rotor (UR), phase loss (PL), and unbalanced voltage (UV). Each of the conditions is run at 2000 RPM and 3000 RPM with loads of 0.06 N m and 0.7 N m for a total of 32 unique combinations of health conditions and process parameters. For simplicity, each unique combination can be identified with xy where x is 2 or 3 to specify the RPM parameter, and y is “H” or “L” to specify a high or low load parameter (e.g., 3L refers to 3000 RPM with load of 0.06 N m). The signals are then normalized to [−1, 1] and split into 256-point windows for the DL experiments.

### Transfer Learning Experiments

The first set of experiments tests the claim that SSL is a more effective TL pretraining method. The experimental design reflects the following assumptions:
1. labeled training data is available from a source set of process parameters,
2. unlabeled training data is available from a target set of process parameters, and
3. the pretrained model may encounter new fault types once deployed.

This scenario leads to three comparison methods:
Supervised (Source): supervised training on the labeled source domain data
Barlow Twins (Source): self-supervised training on the source domain data (ignoring labels)
Barlow Twins (Target): self-supervised training on the unlabeled target domain data.

All three methods use the same 1D CNN feature extraction backbone G shown in FIG. 3. The supervised network adds the K-class classifier F [symbol] to the backbone, while Barlow Twins adds the projection head H. The networks F [symbol] and G [symbol] are then optimized using stochastic gradient descent and backpropagation with cross-entropy loss. The Barlow Twins model produces projections Z′=H (Gz, [symbol] (X′)) and Z″=H (G [symbol] (X″)) from input batch augmentations X′ and X″ (see Algorithm 2), and the training loss is computed with A=0.01. Both the supervised and self-supervised models are trained for 1000 epochs with an Adam optimizer and learning rate of 0.0005.

To assess the quality and generalizability of each method's representation, the frozen features of each pretrained network are used to train a privileged linear evaluation classifier with access to labeled target domain data from all eight health conditions (the evaluation data set), following conventions in the literature for evaluating SSL models. Access to privileged label information prevents this classifier from being trained and deployed in practice, but it follows the accepted standard for assessing the separability of the underlying feature representations. The evaluation classifier is trained for 75 epochs on the frozen features, and the test set accuracy is used to judge the representation quality.

To simulate the occurrence of new, unseen faults, the source and target domain training data sets are limited to two, four, or six randomly selected health conditions. Since the evaluation data set contains all eight conditions, this corresponds to encountering six, four, or two previously unseen classes after pretraining, respectively.

To capture variation caused by the source/target domain selection, training health conditions, and model initialization, 450 experiments were conducted, 150 for each of the three comparative methods. The 150 runs come from all combinations of two source/target domain pairs (3L→2H or 2H→3L), 15 unique health condition configurations for the source/target training data, and five random seeds (0 through 4). The 15 combinations of training health conditions consisted of five randomly sampled sets for each of two, four, and six health conditions (see FIG. 7). All experiments use an NVIDIA V100 GPU with 32 GB of RAM for hardware acceleration.

### Federated Learning Experiments

The FL experiments determine whether sharing model information between clients with disjoint sets of training conditions will improve the distinguishability of future emerging faults. To evaluate this, two clients are each assigned two randomly selected motor health conditions. Each client has local training data for its two conditions from all process parameters combinations (i.e., 2L, 2H, 3L and 3H). The FL server provides both clients with an initial global model with random weights. In each round of FL, the clients train their local model on their unique set of two health conditions and then return the updated model to the server. The server averages the weights and redistributes the new model to the clients in preparation for the next round of FL (see F).

FL experiments were run for 1000 rounds, and each client trains for 20 local batches in each round. When performing supervised learning, each client updates the weights using cross-entropy loss. For Barlow Twins training, each client uses the cross-correlation loss from. Both supervised learning and Barlow Twins use the same network architectures for TL shown in FIG. 2 and are trained with an Adam optimizer and learning rate of 0.0002.

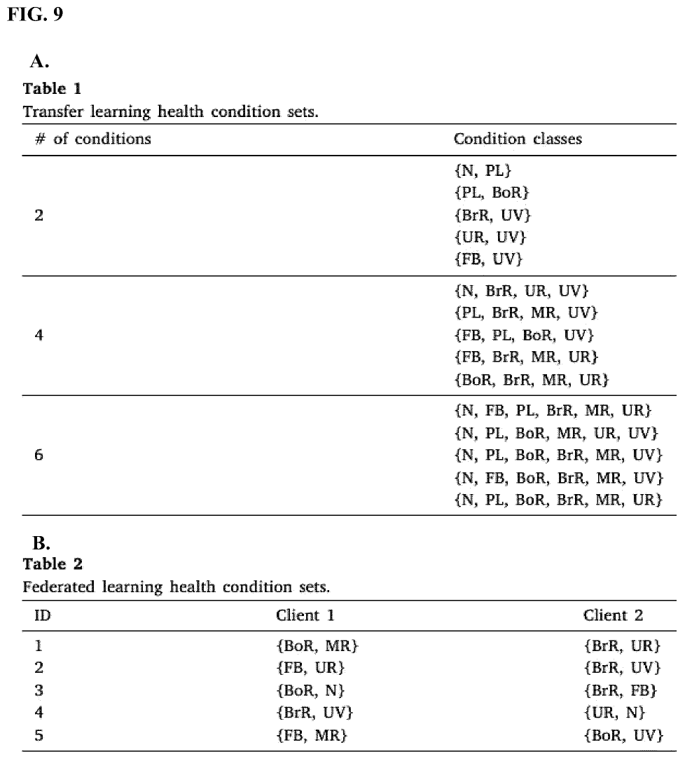

Each of the four possible model configurations—supervised learning and Barlow Twins each with and without FL—is trained with five random seeds (0 through 4) to gauge variation caused by random initialization. Five unique sets of training conditions are tested to marginalize effects of individual health conditions (see FIG. 9B). All combinations of the four methods, five seeds, and five condition sets lead to a total of 100 FL experiments. All experiments use an NVIDIA V100 GPU for hardware acceleration. Similar to TL, both clients are evaluated using the accuracy of a privileged linear classifier trained on the frozen feature extraction network to classify all eight conditions. The classifier is trained for 75 epochs after FL is complete.

### Results and Discussion

The results indicate that Barlow Twins produces more generalizable and transferable representations than supervised learning, and that FL for information sharing may further improve performance.

### Transfer Learning Results

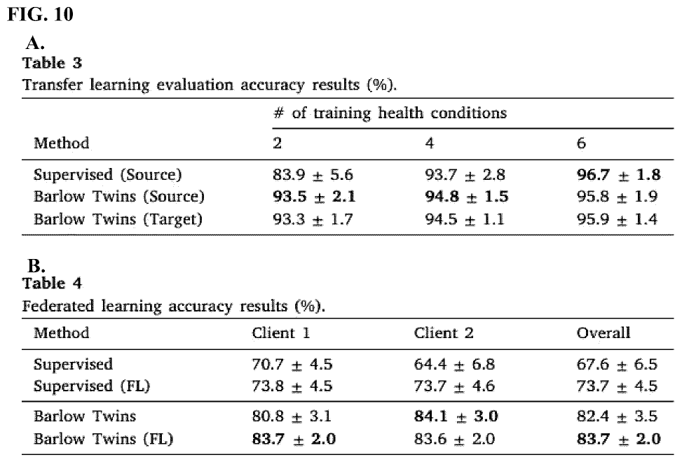

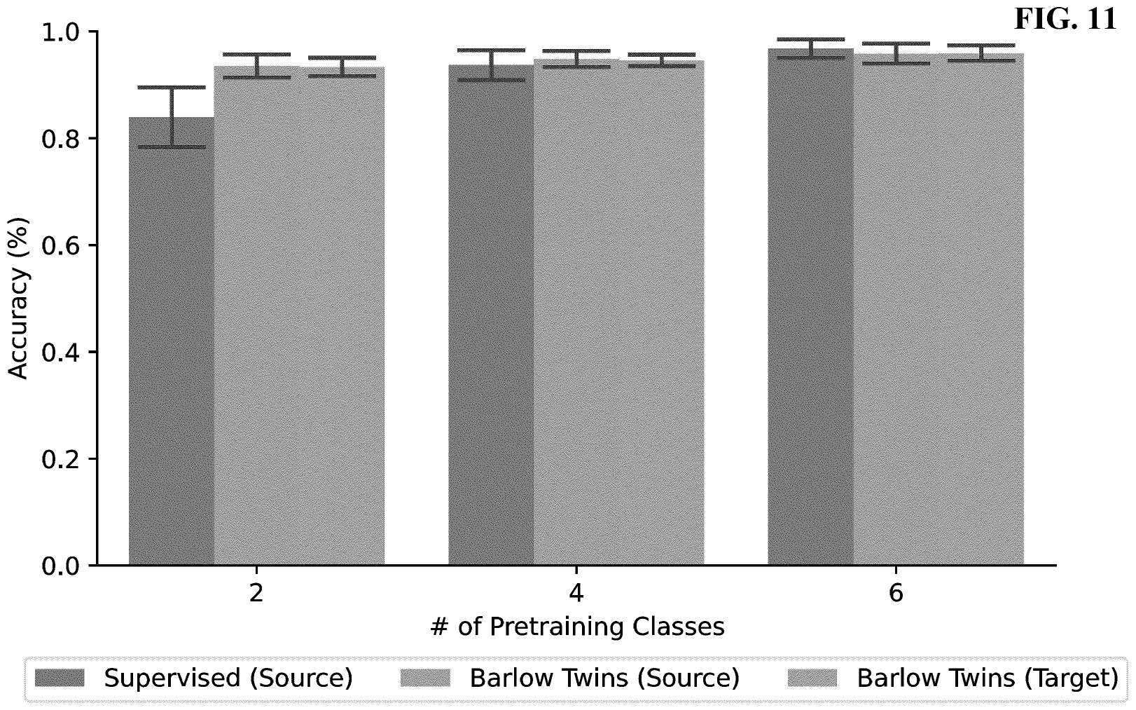

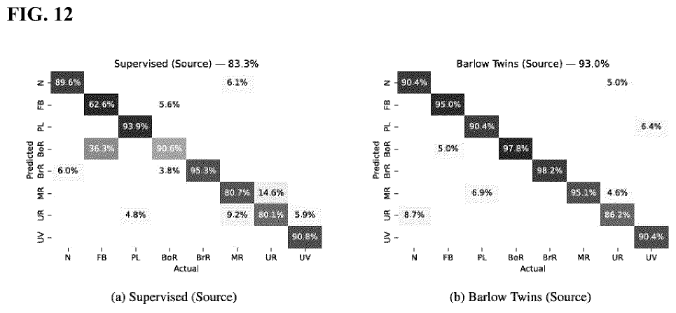

FIGS. 10-11 present the key TL results comparing supervised learning on labeled source process parameters, Barlow Twins on unlabeled source process parameters, and Barlow Twins on unlabeled target process parameters. The accuracy metrics are computed from the test split of the evaluation data set containing all eight conditions under the target process parameters. Even when just two conditions are available for training, Barlow Twins generates a separable representation capable of 93.5% accuracy when shown all eight health conditions. In the same scenario, supervised learning is limited to 83.9% accuracy. FIG. 12 shows representative confusion matrices that highlight the improvements of SSL over supervised learning. For example, supervised learning struggles to distinguish the misaligned rotor (MR) and unbalanced rotor (UR) conditions while using Barlow Twins boosts the accuracy within these categories by 15 and 6 points, respectively. The SSL approach still confuses some classes (e.g., N↔UR and UR→{MR,N}) possibly because the random augmentations could not fully span the expected variation of these classes. That is, data labeled as normal varied more than the expected variation captured by the random jitter, scaling, and masking from Algorithm 2 (see FIG. 13). As a result, Barlow Twins clustered some of these examples closer to UR, leading the evaluation classifier to miscategorize them. Similarly, some PL examples are classified as MR using Barlow Twins representations, indicating that these PL instances experience some variation that clustered them closer to MR. Future work can investigate whether these examples truly are miscategorized or actually resemble members of the confused class. Barlow Twins can also utilize unlabeled target domain data to further improve the representation—Barlow Twins (Target) in FIG. 10—while supervised learning cannot use this data due to the lack of labels. Interestingly, Barlow Twins (Target) does not show a clear improvement over Barlow Twins (Source) indicating that SSL is effective for learning generalizable features from the motor condition monitoring source domain data.

As more conditions are included in training, the performance convergence of supervised learning and Barlow Twins can be explained according to the optimization objective of each approach. Supervised learning seeks to split the data along decision boundaries for the classifier. While this may ensure the training classes are distinguishable, it does not guarantee compactness of the feature clusters. Thus, it is suspected that features from new, emerging faults could overlap with those from faults seen in training. In contrast, Barlow Twins encourages similar input instances to have correlated and closely matching features. This emphasis on feature similarity produces tight clusters that reduce the likelihood of new fault features overlapping with existing clusters. When the number of training conditions increases, the additional decision boundaries created by supervised learning naturally improve feature cluster compactness, bringing its evaluation accuracy closer to that of Barlow Twins. However, because manufacturing applications will have limited class diversity compared to the possible number of emerging faults, these results show the general superiority of SSL-based representations over those transferred from supervised learning in uncertain operating environments.

### Federated Learning Results

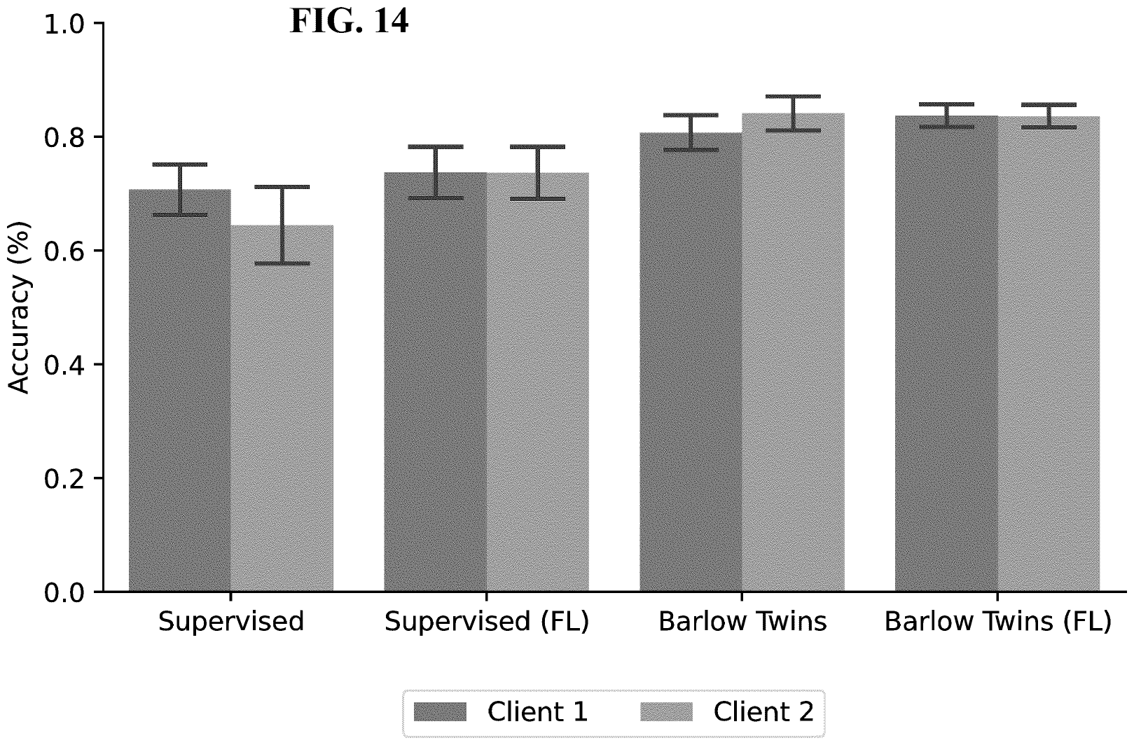

FIG. 10B and FIG. 14 present the FL results. Supervised learning shows an noticeable increase in discriminability of emerging faults when FL is included. Without FL, the overall evaluation accuracy between the clients is only 67.6%. When FL is included, information about the health conditions is shared indirectly through the FedAvg server, boosting the overall accuracy to 73.7%. Since both clients share a global model during FL, they have nearly identical accuracy. When trained without FL, the supervised learning clients show a 6-point discrepancy.

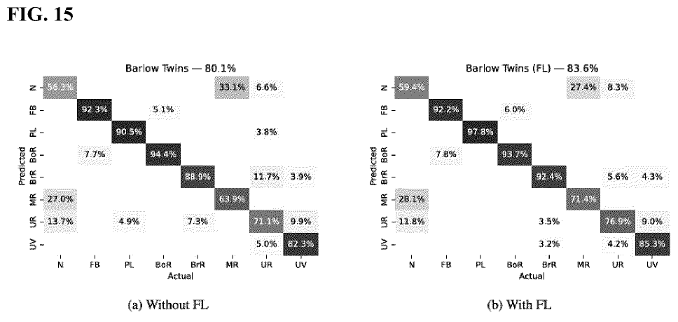

Barlow Twins outperforms all supervised learning methods even when FL is excluded. The separately-trained clients reach an overall evaluation accuracy of 82.4%. Once FL combined with Barlow Twins, performance increases to 83.7%, the highest overall accuracy among all methods. As in the supervised case, FL also reduces the discrepancy between the clients, reducing the accuracy difference from 3.3 points to 0.1 point. The representative confusion matrices in FIG. 15 show in the improvement in Client 1 when FL is included. Phase loss (PL) accuracy increases from 90.5% to 97.8%, and misaligned rotor (MR) accuracy increases from 63.9% to 71.4%. The differences in accuracy with respect to the TL-only results may be a result of training with all sets of process parameters instead of a single source domain set. The Barlow Twins data augmentations might be effective for one or two process parameter sets, they require additional development to capture the class variation expected across all the process parameter combinations. For example, the TL experiments might more easily distinguish N vs. MR and UR because the transfer occurred between 2H↔3L naturally leading to more distant clusters than when data contains only a single process parameter change. While these are directions for future work, these preliminary results demonstrate how indirect information sharing through the FedAvg server may be able to boost discriminability of emerging faults, if the individual clients see a limited number of distinct health conditions. By merging models trained on different subsets of health conditions, FL may increase the diversity of the training data set, improving the generalization of the learned features.

### CONCLUSION

Given growing developments in SSL, this study compares the generalization of feature representations learned via SSL versus those learned via supervised methods. In weight transfer experiments, a feature extractor trained with Barlow Twins outperformed a supervised classifier when transferring to an operating environment with different process parameters that contained emerging faults. With only two health conditions for training, the features learned by Barlow Twins from the source domain produced an evaluation classifier accuracy 9.6 points higher than that of the representation learned by supervised training on labeled source domain data. To further improve performance, knowledge of distributed but similar SSL client models can inform an FL architecture that shares fault experience while respecting privacy concerns. Thus, manufacturing applications with large unlabeled data sets can use SSL and FL to learn generalizable representations for emerging faults even without diverse, labeled data. With enhanced emerging fault detection across conditions, models will be better equipped for the factory floor and improve the trustworthiness and reliability of practical condition monitoring deployments.

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

All patents, patent applications, published applications and publications, GenBank sequences, databases, websites and other published materials referred to throughout the entire disclosure herein, unless noted otherwise, are incorporated by reference in their entirety.

Where reference is made to a URL or other such identifier or address, it understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently-disclosed subject matter, representative methods, devices, and materials are described herein.

The present application can “comprise” (open ended) or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Unless otherwise indicated, all numbers expressing quantities or values are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about” is meant to encompass variations of in some embodiments ±20%, in some embodiments ±10%, in some embodiments ±5%, in some embodiments ±1%, in some embodiments ±0.5%, in some embodiments ±0.1%, in some embodiments ±0.01%, and in some embodiments ±0.001% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

All publications, patents, and patent applications mentioned in this specification are herein incorporated by reference to the same extent as if each individual publication, patent, or patent application was specifically and individually indicated to be incorporated by reference.

It will be understood that various details of the presently disclosed subject matter can be changed without departing from the scope of the subject matter disclosed herein. Furthermore, the foregoing description is for the purpose of illustration only, and not for the purpose of limitation. Obvious modifications and variations are possible in light of the above teachings. All such modifications and variations are within the scope of the appended claims when interpreted in accordance with the breadth to which they are fairly, legally and equitably entitled.

What is claimed:

1. In a computing system environment, a computer-implemented method for machine condition monitoring from unlabeled sensing data, comprising:
providing a plurality of sensors comprising at least one acceleration sensor, the plurality of sensors being adapted for obtaining a plurality of high-frequency time series inputs from an operating rotating machine or rotating machine component; and
providing a central computing device or system comprising memory, storage, and one or more processors configured to receive the plurality of high-frequency time series inputs from the plurality of sensors, the one or more processors including computer-readable instructions for applying one or more augmentation transformations to the plurality of high-frequency time series inputs;
wherein the one or more augmentation transformations diversify the plurality of high-frequency time series inputs without impacting condition information to provide a plurality of augmented inputs, the one or more augmentation transformations being selected to randomize input amplitude and phase.

2. The method of claim 1, further including, by the one or more processors, fusing the plurality of high-frequency time series inputs into a multi-channel input prior to the step of applying the one or more augmentation transformations.

3. The method of claim 1, wherein the one or more processors further include computer-readable instructions for selecting the one or more augmentation transformations from the group consisting of: random flipping, scaling, jitter, masking a random data portion of a high-frequency time series input of the plurality of high-frequency time series inputs, and combinations thereof.

4. The method of claim 3, including scaling with a factor of at least 0.1.

5. The method of claim 1, wherein the one or more processors further include computer-readable instructions for analyzing the augmented inputs according to a Barlow Twins Self-Supervised Learning (SSL) model utilizing a stack-up of one-dimensional convolutional neural network (CNN) residual blocks to provide a restoration loss value, a distillation loss value, and a task loss value.

6. The method of claim 5, wherein the one or more processors further include computer-readable instructions for applying a Mixed-up Experience Replay (MixER) model which uses the restoration loss value, the distillation loss value, and the task loss value to update the Barlow Twins SSL model according to previously observed rotating machine conditions.

7. The method of claim 6, further including, by the one or more processors, classifying a current rotating machine condition according the updated features to predict a required rotating machine maintenance operation or an optimal rotating machine maintenance interval.
